(19) United States
(12) Patent Application Publication
(10) Pub. No.: US 2026/0110525 A1
(43) Pub. Date: Apr. 23, 2026

(54) Light-emitting arrow nock

(71) Applicant: Qice (Shandong) Sports Culture Development Co., Ltd., Jinan (CN)

(72) Inventor: Ce Chen, Jinan (CN)

(21) Appl. No.: 19/422,895

(22) Filed: Dec. 17, 2025

(30) Foreign Application Priority Data
Apr. 14, 2025 (CN) 202520698628.7

(51) Int. Cl. F42B 12/38; F21V 23/02; F21V 33/00; F21W 131/40; F42B 6/06

(52) U.S. Cl. CPC F42B 12/382; F21V 23/023; F21V 33/00; F42B 6/06; F21W 2131/40

(57) ABSTRACT

A light-emitting arrow nock includes a nock assembly, a light-emitting assembly, a power supply assembly and a mounting assembly, wherein the nock assembly and the mounting assembly are installed as an integrated structure, and wherein the light-emitting assembly and the power supply assembly are installed as a whole in internal cavities of the nock assembly and the mounting assembly. The mounting assembly and the nock assembly of the present disclosure are connected through plugging-in or threaded rotation, allowing the power supply assembly to connect to the light-emitting assembly to light on the light-emitting assembly, thereby enabling more convenient and efficient operation and solving the problem of battery disengagement in existing light-emitting arrow nocks. The nock assembly of the present disclosure is provided with at least one external retaining tab on an exterior side thereof.

### TECHNICAL FIELD

The present disclosure relates to the technical field of sports equipment, more particularly to a light-emitting arrow nock.

### BACKGROUND

At present, there are two similar types of light-emitting arrow nocks available on the market (for example, CN207716955U and CN218566312U). These light-emitting arrow nocks have their batteries and main bodies bonded through glue. Under a high draw-weight, the vibration of arrow and the inertial motion of the battery after the arrow hits a target may cause the battery to disengage and enter the inside of an arrow shaft (arrow shafts are of hollow structures), leading to incapability of operation. In addition, since the heads of these light-emitting arrow nocks are designed dedicated for single-string bows, they have middle retaining slots only, without external retaining tabs, hence being unable to adapt to dual-purpose composite bows (dual-purpose composite bows refer to those bows using an integrated magnetic seat that are capable of shooting both arrows and steel balls).

### SUMMARY

In order to solve the above problems in existing technologies, the present disclosure provides a light-emitting arrow nock.

The present disclosure is to solve the technical problems by employing the following technical scheme.

A light-emitting arrow nock includes a nock assembly 3, a light-emitting assembly 4, a power supply assembly 2 and a mounting assembly 1, wherein the nock assembly 3 and the mounting assembly 1 are installed as an integrated structure, and wherein the light-emitting assembly 4 and the power supply assembly 2 are installed as a whole in internal cavities of the nock assembly 3 and the mounting assembly 1.

The present disclosure further includes the following additional technical features.

In a preferable embodiment of the technical scheme of the present disclosure, the nock assembly 3 and the mounting assembly 1 are installed as an integrated structure through plugging-in.

In a preferable embodiment of the technical scheme of the present disclosure, at least two movement limit structures are provided at a connection position between the nock assembly 3 and the mounting assembly 1.

In a preferable embodiment of the technical scheme of the present disclosure, at least one rotation limit structure 314 is provided at a connection position between the nock assembly 3 and the mounting assembly 1.

In a preferable embodiment of the technical scheme of the present disclosure, the nock assembly 3 and the mounting assembly 1 are installed as an integrated structure through threaded rotation.

In a preferable embodiment of the technical scheme of the present disclosure, the nock assembly 3 has a light-emitting assembly cavity formed therein, the light-emitting assembly 4 being placed in the light-emitting assembly cavity; and the mounting assembly 1 has a power supply assembly cavity formed therein, the power supply assembly 2 being placed in the power supply assembly cavity.

In a preferable embodiment of the technical scheme of the present disclosure, the power supply assembly cavity is provided with a power supply assembly limit structure 101 at a front part thereof.

In a preferable embodiment of the technical scheme of the present disclosure, the nock assembly 3 is provided with at least one external retaining tab 301 on an exterior side thereof.

Compared to existing technologies, the present disclosure has the following beneficial effects.

The mounting assembly 1 and the nock assembly 3 of the present disclosure are connected through plugging-in or threaded rotation, allowing the power supply assembly 2 to connect to the light-emitting assembly 4 to light on the light-emitting assembly 4, thereby enabling more convenient and efficient operation and solving the problem of battery disengagement in existing light-emitting arrow nocks.

The nock assembly 3 of the present disclosure is provided with at least one external retaining tab 301 on an exterior side thereof. The design of the external retaining tab 301 enables these light-emitting arrow nocks to adapt to dual-purpose composite bows.

### BRIEF DESCRIPTION OF THE DRAWINGS

FIG. 1 is a perspective view of Embodiment 1 of the present disclosure.

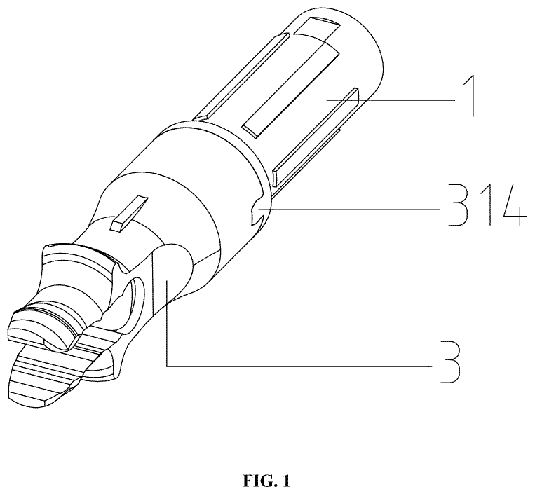

FIG. 2 is a vertical sectional view of Embodiment 1 of the present disclosure.

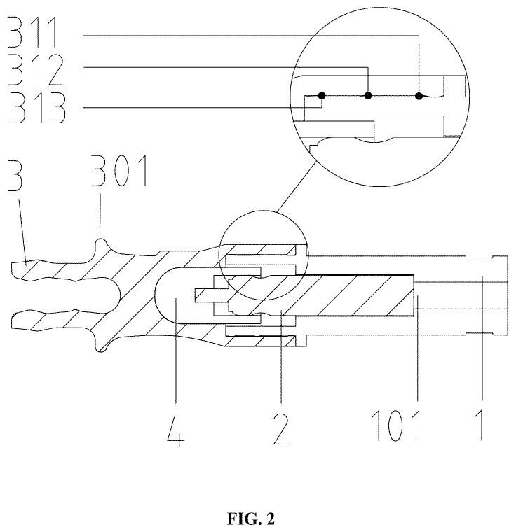

FIG. 3 is a horizontal sectional view of Embodiment 1 of the present disclosure.

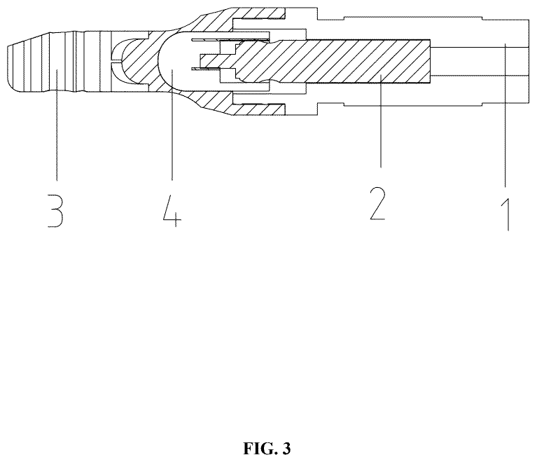

FIG. 4 is a perspective view of Embodiment 2 of the present disclosure.

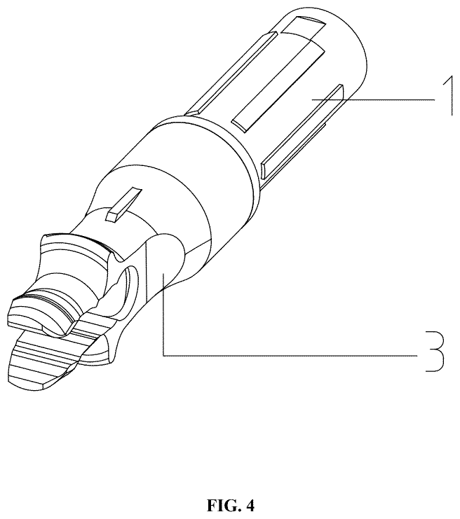

FIG. 5 is a vertical sectional view of Embodiment 2 of the present disclosure.

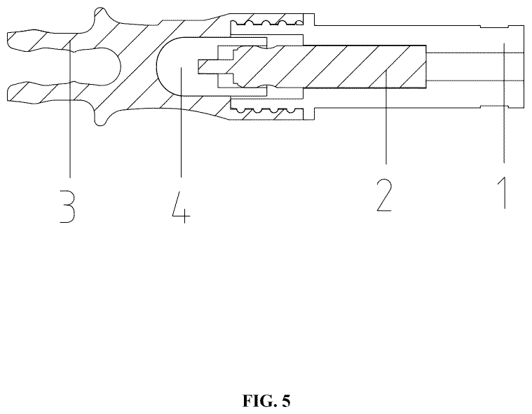

FIG. 6 is a horizontal sectional view of Embodiment 2 of the present disclosure.

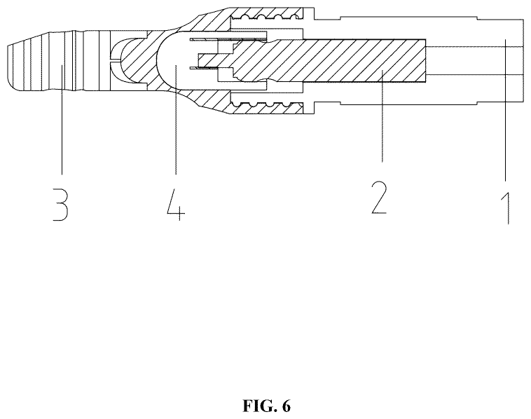

FIG. 7 is a diagram of a connection structure between a power supply assembly 2 and a light-emitting assembly 4 of the present disclosure.

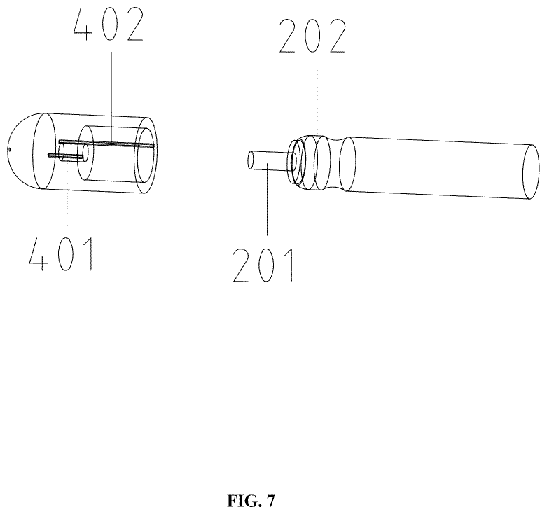

Illustration of reference numerals in the drawings: mounting assembly, 1; power supply assembly, 2; nock assembly, 3; light-emitting assembly, 4.

### DETAILED DESCRIPTION OF THE EMBODIMENTS

Exemplary embodiments of the present disclosure are described below in further detail with reference to the drawings.

### Embodiment 1

A light-emitting arrow nock includes a nock assembly 3, a light-emitting assembly 4, a power supply assembly 2 and a mounting assembly 1, wherein the nock assembly 3 and the mounting assembly 1 are installed as an integrated structure through plugging-in, and wherein the light-emitting assembly 4 and the power supply assembly 2 are installed as a whole in internal cavities of the nock assembly 3 and the mounting assembly 1.

Preferably, at least two movement limit structures are provided at a connection position between the nock assembly 3 and the mounting assembly 1.

When there are two movement limit structures provided, they are a movement limit structure I 311 and a movement limit structure II 312 respectively. In this case, when the nock assembly 3 is moved leftward, the exterior side of the connection position between the nock assembly 3 and the mounting assembly 1 moves from the movement limit structure I 311 to the movement limit structure II 312, and the nock assembly 3 dives the light-emitting assembly 4 to move leftward, making the circuit disconnected between the light-emitting assembly 4 and the power supply assembly 2. The function of the movement limit structure II 312 is to prevent the nock assembly 3 and the mounting assembly 1 from further displacement and disengagement.

When there are three movement limit structures provided, they are a movement limit structure I 311, a movement limit structure II 312 and a movement limit structure III 313 respectively. In this case, when the nock assembly 3 is moved leftward, the exterior side of the connection position between the nock assembly 3 and the mounting assembly 1 moves from the movement limit structure I 311 to the movement limit structure II 312, and the nock assembly 3 dives the light-emitting assembly 4 to move leftward, making the circuit disconnected between the light-emitting assembly 4 and the power supply assembly 2. The functions of the movement limit structure II 312 and the movement limit structure III 313 are to prevent the nock assembly 3 and the mounting assembly 1 from further displacement and disengagement.

The design of the movement limit structures can prevent the nock assembly 3 and the mounting assembly 1 from displacement and disengagement after they are installed, ensuring that the light-emitting assembly 4 and the power supply assembly 2 will not be displaced, disengaged or disconnected due to an excessive thrust force generated when the arrow is shot out.

Preferably, at least one rotation limit structure 314 is provided at a connection position between the nock assembly 3 and the mounting assembly 1. The rotation limit structure 314 is in a snap-fit design. When there are two rotation limit structures 314 provided, the two rotation limit structures 314 are designed to be symmetrical.

The design of the rotation limit structure 314 can prevent the nock assembly 3 and the mounting assembly 1 from rotation and displacement after they are installed, avoiding the light-emitting assembly 4 and the power supply assembly 2 being displaced, disengaged and disconnected.

Preferably, the nock assembly 3 has a light-emitting assembly cavity formed therein, the light-emitting assembly 4 being placed in the light-emitting assembly cavity; and the mounting assembly 1 has a power supply assembly cavity formed therein, the power supply assembly 2 being placed in the power supply assembly cavity.

The light-emitting assembly cavity and the power supply assembly cavity are consistent with the light-emitting assembly 4 and the power supply assembly 2 respectively in contours, just ensuring the connection of circuit between the light-emitting assembly 4 and the power supply assembly 2 when the nock assembly 3 and the mounting assembly 1 are installed in place.

Preferably, the power supply assembly cavity is provided with a power supply assembly limit structure 101 at a front part thereof.

The design of the power supply assembly limit structure 101 can prevent the power supply assembly 2 from displacement inside the power supply assembly cavity, avoiding the light-emitting assembly 4 and the power supply assembly 2 being displaced, disengaged and disconnected.

### Embodiment 2

A light-emitting arrow nock includes a nock assembly 3, a light-emitting assembly 4, a power supply assembly 2 and a mounting assembly 1, wherein the nock assembly 3 and the mounting assembly 1 are installed as an integrated structure through threaded rotation, and wherein the light-emitting assembly 4 and the power supply assembly 2 are installed as a whole in internal cavities of the nock assembly 3 and the mounting assembly 1.

Preferably, the nock assembly 3 has a light-emitting assembly cavity formed therein, the light-emitting assembly 4 being placed in the light-emitting assembly cavity; and the mounting assembly 1 has a power supply assembly cavity formed therein, the power supply assembly 2 being placed in the power supply assembly cavity.

The light-emitting assembly cavity and the power supply assembly cavity are consistent with the light-emitting assembly 4 and the power supply assembly 2 respectively in contours, just ensuring the connection of circuit between the light-emitting assembly 4 and the power supply assembly 2 when the nock assembly 3 and the mounting assembly 1 are installed in place.

Preferably, the power supply assembly cavity is provided with a power supply assembly limit structure 101 at a front part thereof.

The design of the power supply assembly limit structure 101 can prevent the power supply assembly 2 from displacement inside the power supply assembly cavity, avoiding the light-emitting assembly 4 and the power supply assembly 2 being displaced, disengaged and disconnected.

### Embodiment 3

A light-emitting arrow nock is provided, which is based on Embodiment 1 and Embodiment 2; and the nock assembly 3 is provided with at least one external retaining tab 301 on an exterior side thereof. When there are two external retaining tabs 301 provided, the two external retaining tabs 301 are designed to be symmetrical.

The design of the external retaining tab 301 enables these light-emitting arrow nocks to adapt to dual-purpose composite bows.

As an illustration of the existing technology in Embodiment 1, Embodiment 2 and Embodiment 3, the power supply assembly 2 includes a power supply positive electrode 201 and a power supply negative electrode 202, and the light-emitting assembly 4 includes a lamp bead positive electrode 401 and a lamp bead negative electrode 402. When the nock assembly 3 and the mounting assembly 1 are connected in place, the power supply positive electrode 201 is connected to the lamp bead positive electrode 401, and the power supply negative electrode 202 is connected to the lamp bead negative electrode 402, after which the lamp bead is electrified to light on.

The above detailed description for the embodiments of the present disclosure provided in the drawings is not intended to limit the scope of protection of the present disclosure, but merely to illustrate the selected embodiments of the present disclosure.

What is claimed is:

1. A light-emitting arrow nock, comprising a nock assembly, a light-emitting assembly, a power supply assembly and a mounting assembly, wherein the nock assembly and the mounting assembly are installed as an integrated structure, and wherein the light-emitting assembly and the power supply assembly are installed as a whole in internal cavities of the nock assembly and the mounting assembly.

2. The light-emitting arrow nock according to claim 1, wherein the nock assembly and the mounting assembly are installed as an integrated structure through plugging-in.

3. The light-emitting arrow nock according to claim 2, wherein at least two movement limit structures are provided at a connection position between the nock assembly and the mounting assembly.

4. The light-emitting arrow nock according to claim 2, wherein at least one rotation limit structure is provided at a connection position between the nock assembly and the mounting assembly.

5. The light-emitting arrow nock according to claim 1, wherein the nock assembly and the mounting assembly are installed as an integrated structure through threaded rotation.

6. The light-emitting arrow nock according to claim 2, wherein the nock assembly has a light-emitting assembly cavity formed therein, the light-emitting assembly being placed in the light-emitting assembly cavity; and wherein the mounting assembly has a power supply assembly cavity formed therein, the power supply assembly being placed in the power supply assembly cavity.

7. The light-emitting arrow nock according to claim 6, wherein the power supply assembly cavity is provided with a power supply assembly limit structure at a front part thereof.

8. The light-emitting arrow nock according to claim 2, wherein the nock assembly is provided with at least one external retaining tab on an exterior side thereof.
